(19) United States
(12) Patent Application Publication
(10) Pub. No.: US 2011/0218017 A1
(43) Pub. Date: Sep. 8, 2011

(54) APPARATUS AND METHOD FOR DIALING IN MOBILE TERMINAL

(75) Inventor: Sung-In KIM, Incheon (KR)

(73) Assignee: SAMSUNG ELECTRONICS CO. LTD., Suwon-si (KR)

(21) Appl. No.: 13/036,222

(22) Filed: Feb. 28, 2011

(30) Foreign Application Priority Data
Mar. 2, 2010 (KR) 10-2010-0018407

(51) Int. Cl. H04W 88/02

(52) U.S. Cl. 455/550.1

(57) ABSTRACT

An apparatus and a method for dialing in a mobile terminal are provided. More particularly, an apparatus and a method for performing dialing while maintaining communication with a counterpart user are provided. The apparatus includes a touch determining unit and a dial determining unit. When detecting a touch input of a dial pad while performing communication, a touch determining unit determines dial information of a position at which the touch input has been detected. The dial determining unit provides the dial information determined by the touch determining unit as voice information.

### PRIORITY

This application claims the benefit under 35 U.S.C. §119(a) of a Korean patent application filed in the Korean Intellectual Property Office on Mar. 2, 2010 and assigned Serial No. 10-2010-0018407, the entire disclosure of which is hereby incorporated by reference.

### BACKGROUND OF THE INVENTION

1. Field of the Invention

The present invention relates to an apparatus and a method for dialing in a mobile terminal. More particularly, the present invention relates to an apparatus and a method for performing dialing while maintaining communication with a counterpart user.

2. Description of the Related Art

As mobile terminal technology has developed rapidly, the mobile terminal has become a necessity for most people and is widely used regardless of age or sex, and is specifically used as a medium capable of performing wireless voice communication and information exchange.

In an early stage of distribution, a mobile terminal was simply recognized as a product that can be carried and enable wireless communication. As the technology thereof further develops, service providers and terminal manufacturers competitively develop a product (or a service) for differentiation from other companies.

For example, the mobile terminal has developed into a multimedia device capable of providing various services such as a phonebook, a game, a Short Message Service (SMS), an Electronic (E)-mail, a morning call, a Motion Picture Expert Group (MPEG)-1 or MPEG-2 Audio Layer-3 (MP3) player, a schedule management function, a digital camera, a wireless Internet service, and the like.

A user of the mobile terminal may have to perform separate dialing while performing communication with a counterpart user. For example, in the case where the user uses an Automated Response System (ARS) service, the user has to select a dial corresponding to a guiding voice.

As described above, for the user of the mobile terminal to perform dialing during communication, the user has to detach the mobile terminal from his ear and then select a desired dial from a dial pad output on a screen.

However, in this case, the user of the mobile terminal has to position the mobile terminal to a position distant away from this body in order to visually recognize the dial pad. Accordingly, the user of the mobile terminal cannot hear a counterpart user's voice output from a speaker, and cannot properly input the user's voice to a microphone. In other words, the user of the mobile terminal has an inconvenience of having to suspend communication while inputting the dial.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for allowing a user to perform dialing while the user performs communication in a mobile terminal.

Another aspect of the present invention is to provide an apparatus and a method for determining a position that allows dialing while performing communication in a mobile terminal.

In accordance with an aspect of the present invention, an apparatus for performing dialing during communication in a mobile terminal is provided. The apparatus includes a touch determining unit for, when detecting a touch input of a dial pad while performing communication, determining dial information of a position at which the touch input has been detected, and a dial determining unit for providing the dial information determined by the touch determining unit as voice information.

In accordance with another aspect of the present invention, a method for performing dialing during communication in a mobile terminal is provided. The method includes, when detecting a touch input of a dial pad while performing communication, determining dial information of a position at which the touch input has been detected, and providing the determined dial information as voice information.

In accordance with further another aspect of the present invention, an apparatus for performing dialing during communication in a mobile terminal is provided. The apparatus includes a touch determining unit for, when detecting a touch input of a dial pad while performing communication, determining dial information of a position at which the touch input has been detected, and for, when detecting movement of the touch input, determining dial information of a position to which the touch input has moved, a dial determining unit for providing the dial information determined by the touch determining unit as voice information, a sensor for determining a distance between the mobile terminal and a user, and a controller for processing to perform dialing during communication using sensing information of the sensor, wherein when determining that the touch input is released, the touch determining unit inputs the determined dial.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a mobile terminal that outputs information of a dial selected by a user while outputting a counterpart user's communication contents according to an exemplary embodiment of the present invention;

FIG. 2 is a flowchart illustrating a process for allowing a user of a mobile terminal to perform dialing during communication according to an exemplary embodiment of the present invention;

FIG. 3 is a flowchart illustrating a process for performing dialing during communication in a mobile terminal according to an exemplary embodiment of the present invention;

FIG. 4A is a view illustrating a process for performing dialing during communication in a conventional mobile terminal;

FIG. 4B is a view illustrating a process for performing dialing during communication in a mobile terminal according to an exemplary embodiment of the present invention; and

FIG. 5 is a flowchart illustrating a process for determining a situation where dialing can be performed during communication in a mobile terminal according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide an apparatus and a method for outputting a counterpart user's communication contents and simultaneously outputting information regarding a touched dial by outputting the information regarding the dial corresponding to the position touched by a user as voice data when determining that a mobile terminal is located at a position that allows dialing while performing communication.

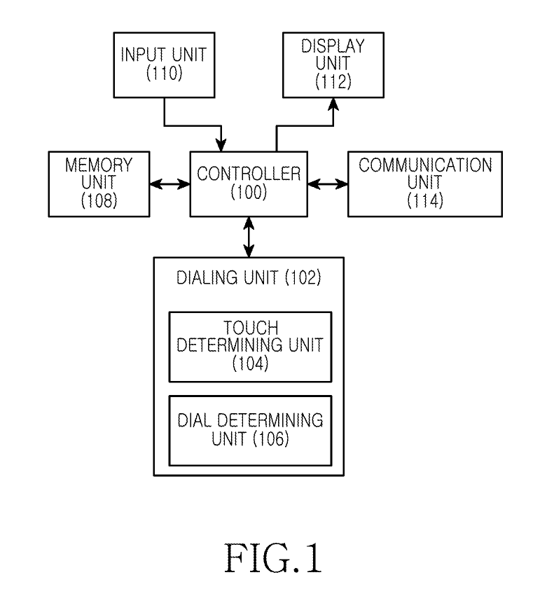

FIGS. 1 through 5, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly state otherwise. A set is defined as a non-empty set including at least one element.

FIG. 1 is a block diagram illustrating a mobile terminal that outputs information of a dial selected by a user while outputting a counterpart user's communication contents according to an exemplary embodiment of the present invention.

Referring to FIG. 1, the mobile terminal may include a controller 100, a dialing unit 102, a memory unit 104, an input unit 108, a display unit 110, and a communication unit 112. The dialing unit 102 may include a touch determining unit 104 and a dial determining unit 106. The mobile terminal may include additional units that are not illustrated here merely for sake of clarity. Similarly, the functionality of two or more of the above units may be integrated into a single component.

The controller 100 of the mobile terminal controls an overall operation of the mobile terminal. For example, the controller 100 performs processes and controls for voice communication and data communication. In addition to the general functions, according to an exemplary embodiment of the present invention, the controller 100 processes to provide information regarding a dial touched by a user as a voice when determining that the mobile terminal is located at a position separated from the user by at least a predetermined distance in order to allow the user of the mobile terminal to freely perform dialing while performing communication. Here, the position at which the mobile terminal is located denotes a position separated by a minimum distance at which the user may maintain communication with a counterpart user (a position separated such that the user may hear the counterpart user's voice and a microphone may detect a voice to be transferred to the counterpart user).

Accordingly, the user of the mobile terminal may position the mobile terminal at the above-described position, and then perform dialing by inputting a dial on a dial pad. At this point, the user will not visually recognize the dial pad by positioning the mobile terminal at the position for minimally maintaining communication.

According to an exemplary embodiment of the present invention, the controller 100 determines a dial touched at the position by the user of the mobile terminal, provides information regarding the determined dial as voice information, and, when the user's touch input is released, recognizes the relevant dial to perform dialing. That is, when a touch input occurs, the controller 100 provides information regarding the dial input by the user, and when the touch input is released, the controller 100 processes dialing corresponding to the touch input by the user.

Therefore, the user of the mobile terminal may determine the dial selected by the user himself under a situation where the user cannot recognize the dial pad. When determining that a touch input for a dial desired by the user is not normally performed with reference to the voice information, the user may be provided with information regarding another dial by performing touch movement with the touch input maintained.

In addition, the controller 100 processes to perform dialing during communication using sensing information of a sensor by determining a distance between the mobile terminal and the user. That is, the controller 100 determines a position change of the mobile terminal through the sensor, and compares the position of the mobile terminal with a threshold to determine whether the user can receive dialing guidance during communication.

When determining that the mobile terminal is at a position separated from the user by a predetermined distance, the dialing unit 102 processes to output the dial pad on the display unit 112, and output dial information corresponding to the user's touch input as voice information under control of the controller 100. Furthermore, when receiving dial information that the user's touch input has been released from the touch determining unit 104, the dialing unit 102 processes to perform dialing corresponding to the dial for which the touch input has been released.

The touch determining unit 104 of the dialing unit 102 determines a touch input point corresponding to a dial that the user intends to input. When determining that a touch input performed for inputting the dialing has been released, the touch determining unit 104 provides the dial for which the touch input has been released to the dialing unit 102.

The dial determining unit 106 of the dialing unit 102 provides dial information determined by the touch determining unit 104 as voice information.

The memory unit 108 includes Read Only Memory (ROM), Random Access Memory (RAM), a flash ROM, and like. The ROM stores microcodes of programs for processes and controls of the controller 100 and the dialing unit 102, and various reference data.

The RAM serves as a working memory of the controller 100 and stores temporary data that occur during execution of various programs. In addition, the flash ROM stores various updatable data for storage such as a phonebook, calling messages, received messages, and the like.

The input unit 110 includes a plurality of function keys such as numerical key buttons of 0 to 9, a menu button, a cancel button, an OK button, a TALK button, an END button, an Internet access button, navigation key buttons, letter input keys, and like. The input unit 110 provides key input data corresponding to a key pressed by a user to the controller 100.

The display unit 112 displays status information generated during an operation of the mobile terminal, letters, a large amount of moving images and still images, etc. The display unit 112 may be a color Liquid Crystal Display (LCD), an Active Matrix Organic Light Emitting Diode (AMOLED), and the like. The display unit 112 may include a touch input device, and when it is applied to a touch input type mobile terminal, it can be used as an input unit.

The communication unit 114 transmits/receives a Radio Frequency (RF) signal of data input/output via an antenna (not illustrated). For example, during transmission, the communication unit 114 channel-codes and spreads data to be transmitted, and then performs an RF process on the signal to transmit the signal. During reception, the communication unit 114 converts a received RF signal into a baseband signal, and despreads and channel-decodes the baseband signal to recover data.

The function of the dialing unit 102 may be performed by the controller 100 of the mobile terminal The separate configuration and illustration of the dialing unit 102 are exemplary only for convenience in description, not for limiting the scope of the present invention. It would be obvious to those skilled in the art that various modifications may be made within the scope of the present invention. For example, all functions of the dialing unit 102 may be processed by the controller 100.

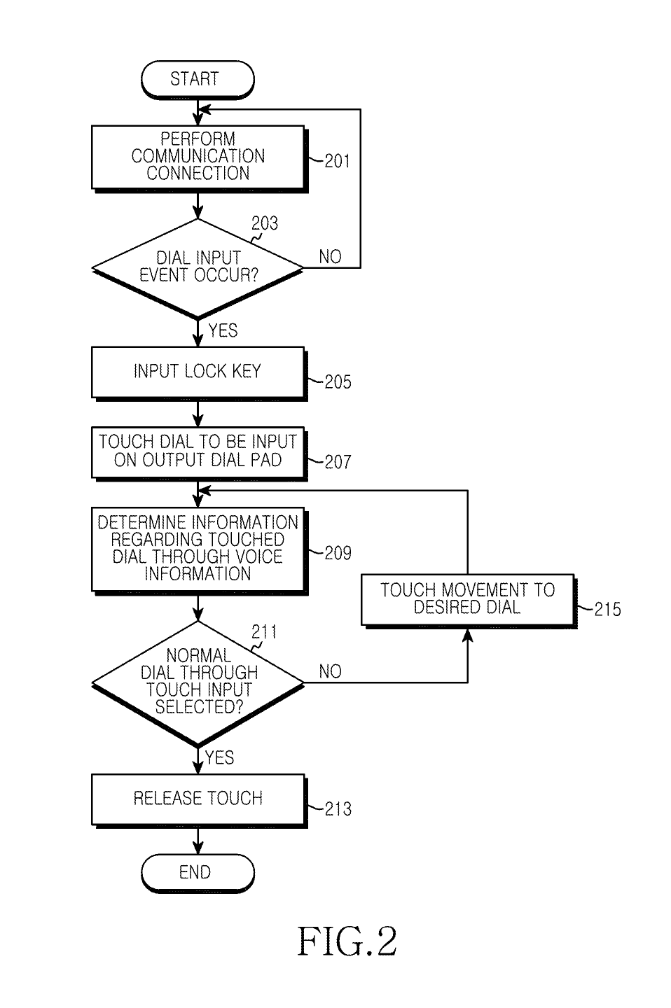

FIG. 2 is a flowchart illustrating a process for allowing a user of a mobile terminal to perform dialing during communication according to an exemplary embodiment of the present invention.

Referring to FIG. 2, the user of the mobile terminal performs communication with a counterpart user in step 201, and determines whether a dial input event occurs in step 203. Here, the dial input event denotes a case (e.g., a user uses an ARS, a visually handicapped user inputs a dial (key), and the like) where the user cannot visually recognize a dial pad (keypad) for inputting a dial, and inputs a dial while performing communication with the counterpart user.

If it is determined in step 203 that the dial input event does not occur, the user of the mobile terminal repeatedly performs the process of step 201.

In contrast, if it is determined in step 203 that the dial input event occurs, the user of the mobile terminal proceeds to step 205 to perform a process for inputting a lock key to output a dial pad. Here, the lock key denotes a key for setting or releasing a screen lock function performed to prevent an unnecessary touch input by a body contact. According to an exemplary embodiment of the present invention, the user of the mobile terminal inputs the lock key to output the dial pad. That is, step 205 serves as a process for inputting a specific key for outputting the dial pad for dial selection, and the specific key for outputting the dial pad is not limited to the lock key.

The user of the mobile terminal proceeds to step 207 to touch a dial to be input on the dial pad output in step 205.

At this point, the mobile terminal is located apart at a position (the user may listen to a counterpart user's voice and a microphone may detect a voice to be transferred to the counterpart user) such that the user may maintain communication with the counterpart user. The user of the mobile terminal may maintain communication with the counterpart user but cannot visually recognize the dial pad for selecting a dial. However, according to an exemplary embodiment of the present invention, when the user performs a touch input on the dial pad while performing communication, the mobile terminal provides information of a dial corresponding to the touch input as voice information.

In step 209, the user of the mobile terminal determines information of the dial touched on the dial pad by the user through the voice information corresponding to the touch input.

In step 211, the user of the mobile terminal determines whether the user has selected a correct dial through the performed touch input.

For example, assuming that the user of the mobile terminal intends to input a dial of “5” while performing communication, the user determines whether the voice information output by the mobile terminal is “5”.

If it is determined in step 211 that the user has not selected the correct dial through the touch input, the user of the mobile terminal proceeds to step 215 to perform a touch movement to a desired dial and repeatedly perform the process of step 209. As the user may recognize a key button position of the dial pad, the user selects a desired dial using voice information.

In contrast, if it is determined in step 211 that the user has selected the correct dial through the touch input in step 211, the user of the mobile terminal proceeds to step 213 to release the touch input to allow the selected dial to be input.

After that, the user of the mobile terminal ends the present algorithm.

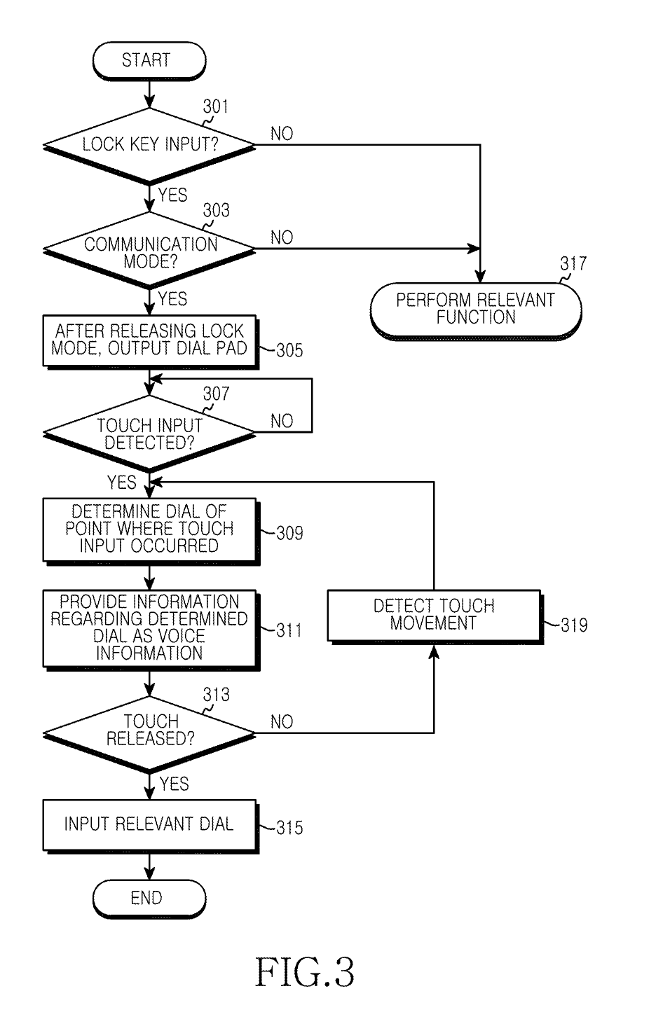

FIG. 3 is a flowchart illustrating a process for performing dialing during communication in a mobile terminal according to an exemplary embodiment of the present invention.

Referring to FIG. 3, the mobile terminal determines whether a lock key, which is one of specific keys for outputting a dial pad, is input in step 301. Here, the lock key denotes a key for setting or releasing a screen lock function performed to prevent an unnecessary touch input by a body contact. The mobile terminal outputs the dial pad using the lock key during communication. The lock key is described using a specific key for example and is not limited thereto.

If it is determined in step 301 that the lock key is not input, the mobile terminal proceeds to step 317 to perform a relevant function (e.g., an idle mode).

In contrast, if it is determined in step 301 that the lock key is input, the mobile terminal proceeds to step 303 to determine whether the lock key has been input during a communication mode, that is, while the mobile terminal performs communication.

If it is determined in step 303 that the lock key has been input while the communication mode is not performed, the mobile terminal proceeds to step 317 to perform a relevant function (e.g., a lock mode).

In contrast, if it is determined in step 303 that the lock key has been input during the communication mode, the mobile terminal proceeds to step 305 to output the dial pad. At this point, since the mobile terminal may perform a screen lock mode in order to prevent unnecessary power consumption and unnecessary key input during communication, the mobile terminal may release the lock mode and output the dial pad.

The mobile terminal proceeds to step 307 to determine whether a touch input by a user is detected. Here, the touch input denotes a touch input that the user performs in order to select a dial. Since the user of the mobile terminal intends to select a dial while performing communication, the user has positioned the mobile terminal to a position at which the user cannot visually recognize the dial pad.

When not detecting the touch input by the user in step 307, the mobile terminal repeatedly performs the process of step 307.

In contrast, when detecting the touch input by the user in step 307, the mobile terminal determines a dial of a point where the touch input has been detected in step 309, and proceeds to step 311 to provide information regarding the dial determined in step 309 as voice information.

Therefore, the user who cannot visually recognize the dial pad may determine the dial touched using the voice information.

The mobile terminal determines whether the touch input by the user is released in step 313. Here, when the touch input by the user is released, the dial selected by the user is input.

If it is determined in step 313 that the touch input by the user is not released, the mobile terminal determines that the dial selection desired by the user has not been performed and proceeds to step 319 to detect a touch movement by the user.

In contrast, if it is determined in step 313 that the touch input by the user has been released, the mobile terminal proceeds to step 315 to process to input the dial selected in step 307 by the user.

That is, the mobile terminal may determine the dial selected by the user through the user's touch input and determine the dial that the user intends to re-select through the user's touch movement. In addition, the mobile terminal may determine the dial that the user intends to input through the user's touch input release.

After that, the mobile terminal ends the present algorithm.

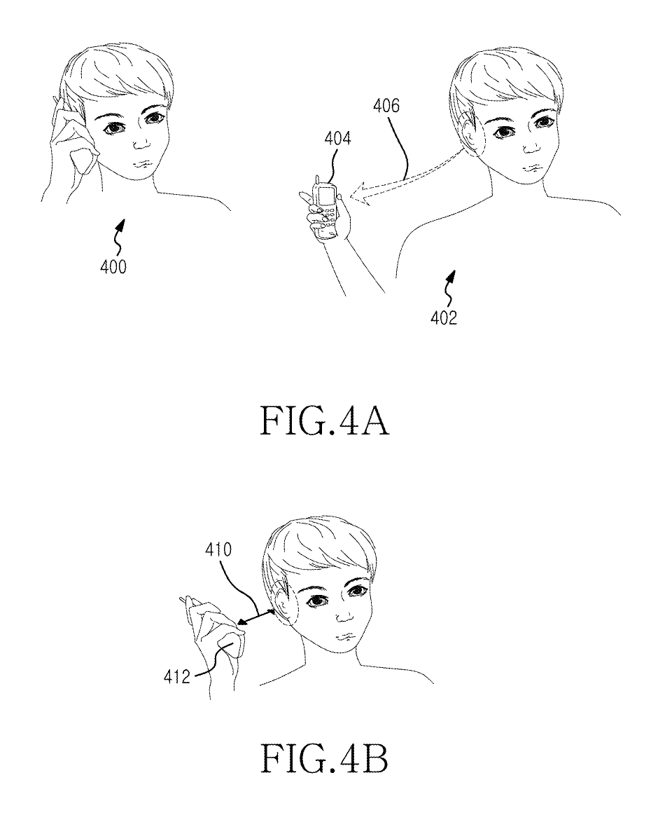

FIGS. 4A-4B are views comparing a process for performing dialing during communication using a mobile terminal according to an exemplary embodiment of the present invention with a dial process of the conventional mobile terminal.

FIG. 4A is a view illustrating a process for performing dialing during communication in a conventional mobile terminal.

Referring to FIG. 4A, a user of the conventional mobile terminal performs communication by allowing the mobile terminal to contact his body as illustrated in 400.

After that, in the case where the user of the mobile terminal intends to perform dialing during communication, the user has to move (406) the mobile terminal 404 from his body up to a position at which the user may visually recognize a dial pad in order to see the dial pad output on the screen of the mobile terminal 404 as illustrated in 402.

In case of positioning the mobile terminal 404 to the position at which the user may recognize the dial pad as described above, the user of the mobile terminal 404 cannot hear a counterpart user's voice output from the speaker and cannot input the user's voice to the microphone. In other words, the user of the mobile terminal has an inconvenience of having to suspend communication while inputting the dial.

FIG. 4B is a view illustrating a process for performing dialing during communication in a mobile terminal according to an exemplary embodiment of the present invention.

Referring to FIG. 4B, a user of the mobile terminal 412 performs communication by allowing the mobile terminal 412 to contact his body.

After that, in the case where the user of the mobile terminal 412 intends to perform dialing during communication, the user moves the mobile terminal 412 to a position (the user may hear a counterpart user's voice and a microphone may detect voice to be transferred to the counterpart user) separated such that the user may maintain communication with the counterpart user as illustrated. The user who has moved the mobile terminal 412 to that position may maintain communication with a counterpart user but cannot visually recognize a dial pad for selecting a dial.

However, according to an exemplary embodiment of the present invention, in the case where the user performs a touch input on the dial pad while performing communication, the mobile terminal 412 allows the user to perform the communication and simultaneously perform dialing corresponding to a touch input by providing information of a dial corresponding to the touch input as voice information.

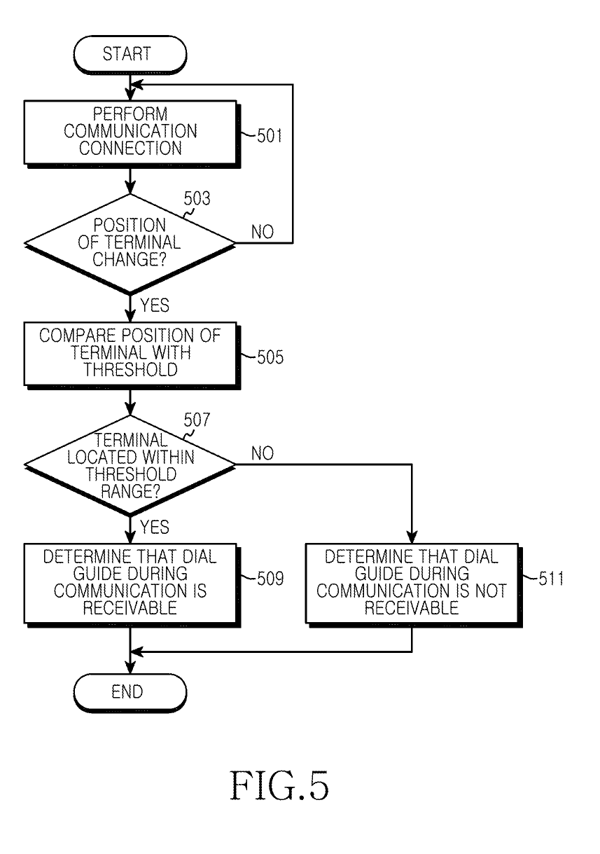

FIG. 5 is a flowchart illustrating a process for determining a situation where dialing can be performed during communication in a mobile terminal according to an exemplary embodiment of the present invention.

Referring to FIG. 5, as described above, though the mobile terminal may perform dialing during communication through input of a specific key (e.g., a lock key), the mobile terminal may automatically perform dialing through a sensor (e.g., a proximity sensor) that may determine a distance from the user according to an exemplary embodiment of the present invention.

To perform dialing during communication, the mobile terminal performs communication with a counterpart user in step 501, and determines whether the position of the mobile terminal changes in step 503. At this point, the mobile terminal may determine the position change of the mobile terminal using the proximity sensor according to an exemplary embodiment of the present invention.

When determining that the position of the mobile terminal does not change in step 503, the mobile terminal re-performs the process of step 501 to maintain the communication.

In contrast, when determining that the position of the mobile terminal changes in step 503, the mobile terminal compares the position of the mobile terminal with a threshold in step 505.

Here, the threshold compared with the position of the mobile terminal serves as a value for determining a position at which the user may perform dialing during communication. A position determined such that a counterpart user's voice may be heard within a distance at which the dial pad of the mobile terminal cannot be visually recognized and a microphone may detect a voice to be transferred to the counterpart user serves as the threshold.

The mobile terminal determines the result of step 505 in step 507.

When determining that the mobile terminal is positioned within the threshold range in step 507, the mobile terminal determines that it can receive a guide regarding a dial for which a touch input has been performed during communication as voice information in step 509.

In contrast, when determining that the mobile terminal is not positioned within the threshold range in step 507, the mobile terminal determines that it cannot receive the guide regarding the dial for which the touch input has been performed during communication as voice information in step 511.

After that, the mobile terminal ends the present algorithm.

As described above, exemplary embodiments of the present invention provide an apparatus and a method for allowing a user to perform dialing while maintaining communication with a counterpart user in a mobile terminal. In the case where the mobile terminal is located at a position such that the user cannot visually recognize the dial pad of the mobile terminal but a microphone may detect a voice to be transferred to the counterpart user, the mobile terminal resolves a problem of not being able to maintain communication while performing a dialing process in the conventional mobile terminal by providing dial information corresponding to the user's touch input as voice information.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for performing dialing during communication in a mobile terminal, the apparatus comprising:
a touch determining unit for, when detecting a touch input of a dial pad while performing communication, determining dial information of a position at which the touch input has been detected; and
a dial determining unit for providing the dial information determined by the touch determining unit as voice information.

2. The apparatus of claim 1, wherein, after the dial determining unit provides the voice information, when determining that the touch input is released, the touch determining unit inputs the determined dial.

3. The apparatus of claim 1, wherein, after the dial determining unit provides the voice information, when detecting movement of the touch input, the touch determining unit determines dial information of a position to which the touch input has moved to provide the same as voice information.

4. The apparatus of claim 1, further comprising:
a sensor for determining a distance between the mobile terminal and a user; and
a controller for processing to perform dialing during communication using sensing information of the sensor.

5. The apparatus of claim 4, wherein the controller detects a position change of the mobile terminal using the sensor and compares a position of the mobile terminal with a threshold to determine whether a dialing guide during communication is receivable.

6. The apparatus of claim 5, wherein the threshold comprises a value for determining a position that allows a user to perform dialing during communication, and the threshold comprises a position that allows the user to hear a counterpart user's voice within a distance at which the dial pad of the mobile terminal is not visually recognizable and that allows a microphone to detect a voice to be transferred to the counterpart user.

7. The apparatus of claim 1, further comprising a controller for determining if a lock key for releasing a screen lock and outputting the dial pad is input.

8. A method for performing dialing during communication in a mobile terminal, the method comprising:
when detecting a touch input of a dial pad while performing communication, determining dial information of a position at which the touch input has been detected; and
providing the determined dial information as voice information.

9. The method of claim 8, further comprising:
determining if the touch input is released after the providing of the determined dial information as voice information; and
when determining that the touch input is released, inputting the determined dial.

10. The method of claim 8, further comprising:
detecting movement of the touch input after the providing of the determined dial information as voice information; and
when detecting movement of the touch input, determining dial information of a position to which the touch input has moved to provide the same as voice information.

11. The method of claim 8, further comprising determining a distance between the mobile terminal and a user.

12. The method of claim 11, further comprising:
determining a position change of the mobile terminal using a sensor for determining the distance; and
comparing a position of the mobile terminal with a threshold to determine whether a dialing guide during communication is receivable.

13. The method of claim 12, wherein the threshold comprises a value for determining a position that allows a user to perform dialing during communication, and the threshold comprises a position that allows the user to hear a counterpart user's voice within a distance at which the dial pad of the mobile terminal is not visually recognizable and that allows a microphone to detect a voice to be transferred to the counterpart user.

14. The method of claim 8, further comprising:
determining if a lock key is input; and
if the lock key is input, outputting the dial pad.

15. An apparatus for performing dialing during communication in a mobile terminal, the apparatus comprising:
a touch determining unit for, when detecting a touch input of a dial pad while performing communication, determining dial information of a position at which the touch input has been detected, and for, when detecting movement of the touch input, determining dial information of a position to which the touch input has moved;
a dial determining unit for providing the dial information determined by the touch determining unit as voice information;
a sensor for determining a distance between the mobile terminal and a user; and
a controller for processing to perform dialing during communication using sensing information of the sensor,
wherein, when determining that the touch input is released, the touch determining unit inputs the determined dial.

16. The apparatus of claim 15, wherein after detecting a position change of the mobile terminal using the sensor, the controller compares a position of the mobile terminal with a threshold to determine whether a dialing guide during communication is receivable.

17. The apparatus of claim 16, wherein the threshold comprises a value for determining a position that allows a user to perform dialing during communication, and the threshold comprises a position that allows the user to hear a counterpart user's voice within a distance at which the dial pad of the mobile terminal is not visually recognizable and that allows a microphone to detect a voice to be transferred to a counterpart user.

18. The apparatus of claim 15, wherein the controller determines if a lock key for releasing a screen lock and outputting the dial pad is input.
